(19) United States
(12) Patent Application Publication
(10) Pub. No.: US 2007/0204888 A1
(43) Pub. Date: Sep. 6, 2007

(54) Apparatus and method for retaining discarded flatware

(76) Inventor: Kenneth M. Miller, Prattsville, AL (US)

Correspondence Address: BURNS & LEVINSON, LLP, 125 SUMMER STREET, BOSTON, MA, 02110, US

(21) Appl. No.: 11/681,564

(22) Filed: Mar. 2, 2007

Related U.S. Application Data
(60) Provisional application No. 60/778,464, filed on Mar. 2, 2006.

(51) Int. Cl. B08B 3/00

(52) U.S. Cl. 134/134

(57) ABSTRACT

A method and apparatus for interrupting flatware from falling into a receptacle allow debris or other material potentially containing flatware to fall through a vertical chute toward a receptacle, sense the presence of flatware within the falling debris or other material and move a hinged panel across the vertical chute in response to the step of sensing to deflect such flatware laterally through an opening in a sidewall of the chute.

### RELATED APPLICATIONS

The present application claims priority from U.S. provisional patent application Ser. No. 60/778,464, filed Mar. 2, 2006.

### FIELD OF THE INVENTION

This invention relates generally to the retention of discarded flatware in the restaurant business, and more particularly, to the interception of flatware pieces being dropped into a garbage receptacle.

### BACKGROUND OF THE INVENTION

It is known that the restaurant and hospitality industry in the United States alone loses millions of dollars in replacing flatware lost by being discarded with dish room garbage and dirty linen in collection. As used herein the term “flatware” typically means table cutlery which might be disposed of in the process of clearing a meal table either with food debris from a plate or with napkins being deposited into a laundry receptacle. The flatware is also intended to mean any other metal objects which might be left on a meal table and accidentally disposed of.

### SUMMARY OF THE INVENTION

In one embodiment of the present invention, an apparatus for interrupting flatware from falling into a receptacle, comprises: a housing adapted for location on top of a receptacle; a chute mounted in the housing and having a vertical section with a bottom opening adapted to access a receptacles a side wall forming part of the vertical section and having a lateral opening there through; a hinged panel adapted to selectively block the vertical section and deflect items falling in the vertical section through the lateral opening in the sidewall.

The apparatus may further comprise a catch basin positioned adjacent to the lateral opening. The apparatus may further comprise a removable catch basket adapted for location within the catch basin. The removable catch basket may have at least one partially enclosed side adapted to retain latterly moving flatware within the catch basket. The catch basket may have enclosed sides and top adapted to retain flatware moving through the lateral opening. The apparatus may further comprise a safety device adapted to prevent the movement of the hinged panel when the catch basket is not located within the catch basin. The catch basin and the catch basket may each have an open mesh bottom sized to retain a smallest dimension of flatware.

The apparatus may further comprise a metal detector adapted for sensing flatware moving either rough or towards the chute and located within the housing and adjacent to the chute at a level higher than the lateral opening. The hinged panel may be hinged at either a top or bottom thereof

The housing may further include one or more downwardly and laterally sloping surfaces extending to the chute and adapted to receive materials intended for the chute. The chute may be removable from the housing in a simple manner to facilitate washing.

In another embodiment of the present invention, a method for interrupting flatware from falling into a receptacle, comprises of the steps of: allowing debris or other material potentially containing flatware to fall through a vertical chute toward a receptacle; sensing the presence of flatware within the falling debris or other material; and moving a hinged panel across the vertical chute in response to the step of sensing to deflect such flatware laterally through an opening in a sidewall of the chute.

The method may further comprise locating a catch basin adjacent the lateral opening in the chute to receive flatware moved through the chute by the step of moving a hinged panel. The method may further comprise locating a catch basket within the catch basin and adjacent to the lateral opening.

The method may further comprise the step of retaining flatware moving through the lateral opening in the catch basket. The method may further comprise the step of disabling the step of moving if the catch basket is not located within the catch basin.

The method may further comprise the step of initially receiving the debris or other material on a downwardly and laterally sloping surface adjoining the chute.

### BRIEF DESCRIPTION OF THE DRAWINGS

The present invention may best be understood from the following detailed description of the embodiments illustrated in the drawings, wherein:

FIG. 1 is a perspective view of an apparatus constructed in accordance with one embodiment of the present invention;

FIG. 2 is a side schematic view of the apparatus of FIG. 1;

FIG. 3 is another perspective view of the apparatus of FIG. 1 shown in a different operative condition;

FIG. 4 is a side schematic view of the apparatus as shown in FIG. 3;

FIG. 5 is a partially sectioned side schematic view of an apparatus constructed in accordance with another embodiment of the present invention;

FIG. 6 is a partially sectioned side schematic view of the apparatus of FIG. 5 having a different operative condition;

FIG. 7 is a partially sectioned side schematic view of an apparatus constructed in accordance with vet another embodiment of the present invention.

### DETAILED DESCRIPTION OF PREFERRED EMBODIMENTS

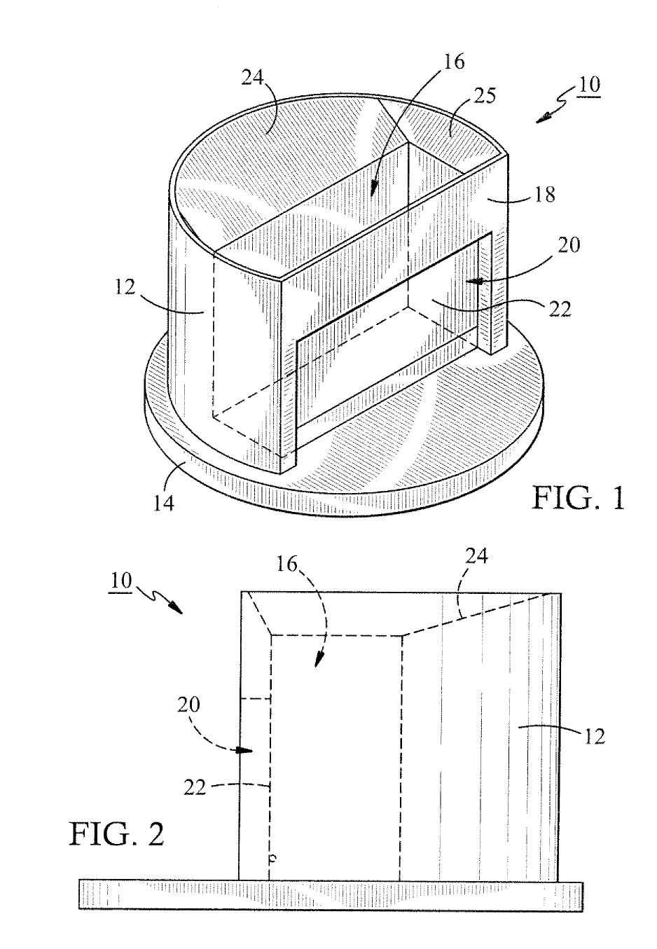

The perspective view of FIG. 1 shows an apparatus 10 generally including a housing 12 and a base 14. The housing 12 includes a chute 16 and a flat side 18 having a lateral opening 20 covered by a door or flat panel 22. The top of housing 12 also includes one or more surfaces 24, 25 which slope downwardly and laterally towards vertical chute 16. The side schematic view of FIG. 2 shows the same apparatus 10 with housing 12 and base 14 and shows vertical chute 16 being open and clear of obstruction. Apparatus 10 is intended to be located on top of a standard sized garbage barrel or receptacle.

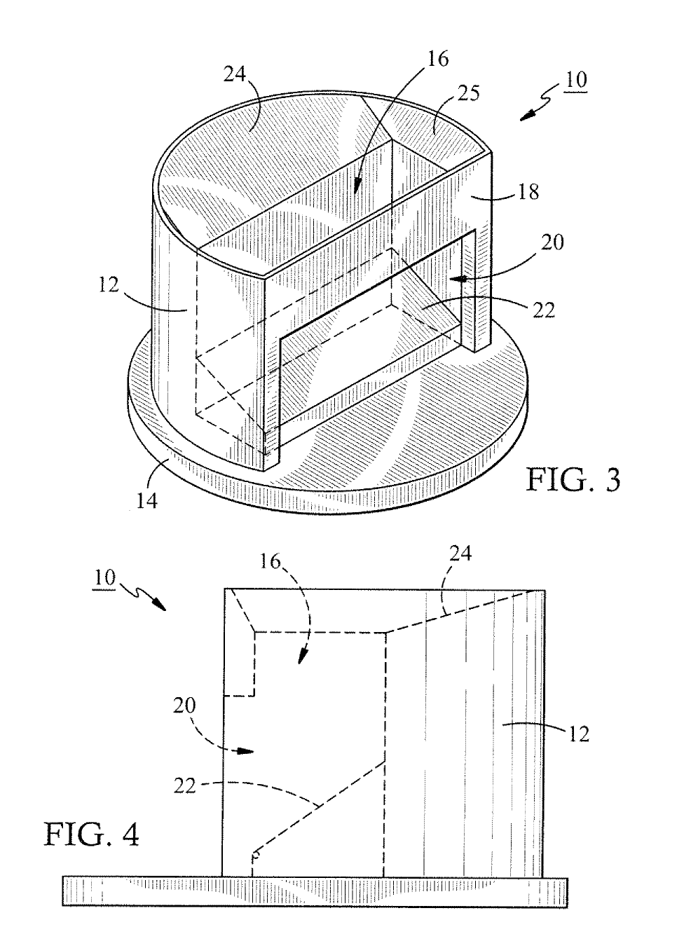

FIG. 3 shows the same perspective view of apparatus 10 as FIG. 1 except that the door or flat panel 22 which is hinged along its bottom edge 23, is in the open position. The schematic side view of FIG. 4 reflects this condition because flat panel 22 walks chute 16 and opens lateral opening 20.

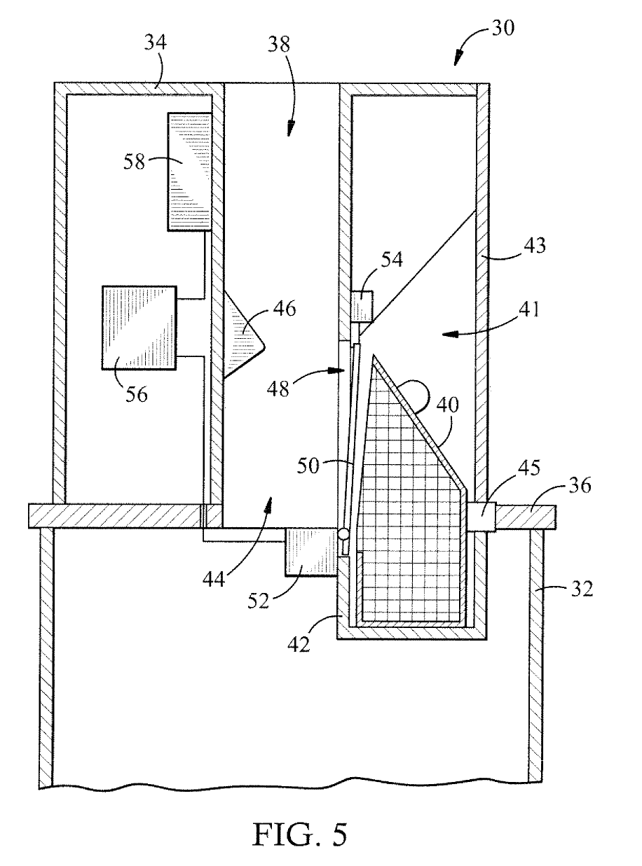

FIG. 5 shows an apparatus 30 located on top of a garbage receptacle 32. Apparatus 30 generally includes a housing 34, a base 36 a centrally located chute 38 and a flatware catch basket 40. Catch basket 40 is removably located within a catch basin 42. All parts of apparatus 30 are mounted to base 36 to derive support from the top of garbage barrel 32 and are sized to properly fit on top of a standard barrel. Centrally located chute 38 is vertical and includes a bottom opening 44, which directly accesses garbage barrel 32 to enable food debris dropped into chute 38 to directly access garbage barrel 32 with minimal deflection and resulting build up of food scraps. Chute 38 does include one deflector 46 which extends across chute 38 in the direction normal to the plane of the drawing. Chute 38 further includes a lateral opening 48 to allow the recovery of flatware items falling through chute 38. Lateral opening 48 is the location of a door or flat panel 50, which is used to block chute 38 and intercept the travel of flatware there through. Flat panel 50 is connected to a suitable drive mechanism 52 and is also shown to be retained in a closed position by a catch 54. Any suitable drive mechanism 52 may be used including a spring bias to quickly open flat panel 50 upon the release of catch 54. The opening of flat panel 50 is controlled by a controller 56 which is directly wired to drive mechanism 52 and catch 54. Controller 56 operates in response to the sensing of flatware within chute 38 by a magnetic sensor 58 located within housing 34.

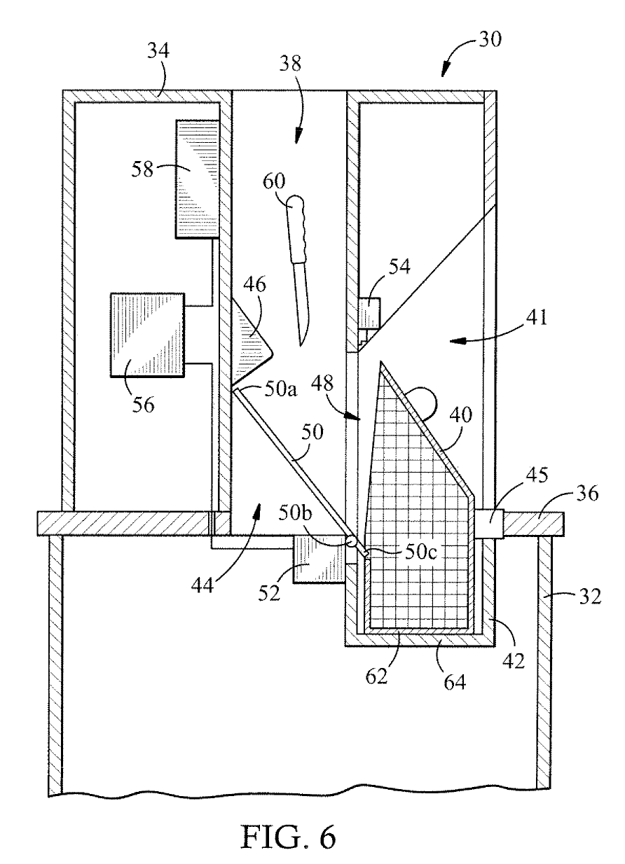

FIG. 6 is the same view of apparatus 30 as FIG. 5 except that the flat panel 50 is located in the open position to diverge the fall of flatware 60 through chute 38 and send it laterally into catch basket 40. The upper edge 50a of panel 50 is shown to reach underneath deflector 46 to catch all debris currently falling through chute 38. It can also be noted that flat panel 50 is hinged at point 50b before it∝s end 50c so that end 50c extends over basket 40 with flat panel 50 in the open position.

FIG. 6 further differs from FIG. 5 in that recess 41 is shown to be open from the side of housing 34. Alternatively recess 41 may be closed by a door 43 (FIG. 5). A safety device 45 may be used to sense either the proper closure of door 43 or the proper location of catch basket 40, or both. Device 45 can be connected to interrupt the operation of apparatus 30 unless it is indicating a safe condition. Without the appropriate safety conditions, flatware falling through chute 38 might be expelled through lateral opening 48 and present a hazardous condition.

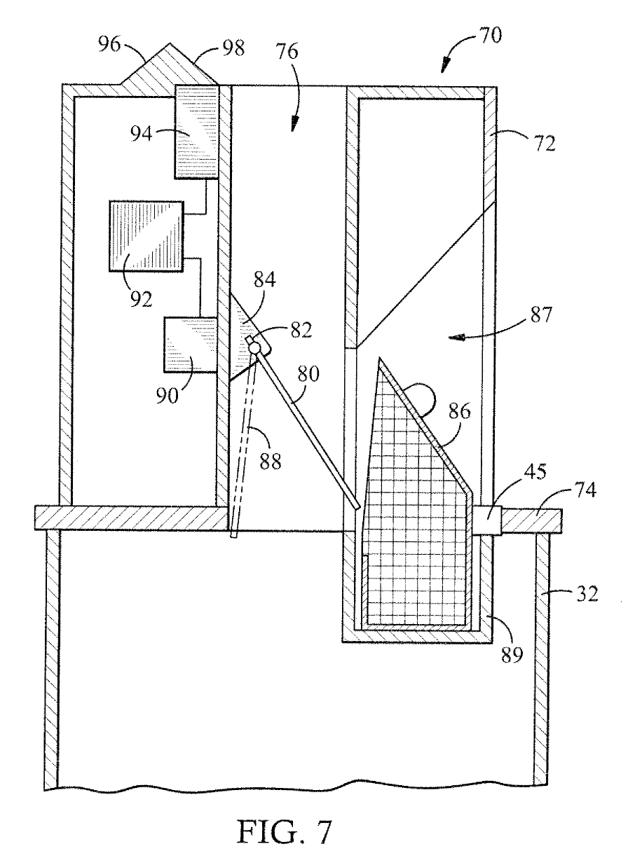

FIG. 7 is a side schematic view of another apparatus 70 constructed in accordance with yet another embodiment of the present invention. Apparatus 70 includes a similar housing 72, base 74 and centrally located vertical chute 76, as the embodiments of FIGS. 5 and 6. Apparatus 70 also includes a door or flat panel 80, which is hinged from its upper end 82 and beneath deflector 84. Flat panel 80 is shown in the interrupt or intercept position to cause flatware falling within chute 76 to bounce laterally into catch basket 86. FIG. 7 also shows a phantom line 88 where flat panel 80 would be located during the normal operation of apparatus 70 in the absence of flatware in chute 76. Panel 80 may be activated by drive mechanism 90 and similarly controlled by a controller 92 working in response to a metal detector 94.

Housing 72 and apparatus 70 further include an upward protrusion 96 which allows a higher location for metal or magnetic detector 94. This provides more time for the activation of flat panel 80 in the presence of flatware within chute 76. Protrusion 96 further provides a downwardly and laterally sloping surface 98 which may be used for the direction of waste towards chute 76. The metal or magnetic detector 94 may be of a type that detects only silver so that only silverware is to be retrieved. Alternatively, the metal detector 94 may be of a type that detects any type of metal that is used in the manufacture of flatware in order to retrieve all types of metal flatware.

Catch baskets 40, 86 are shown to have a wire screen construction with openings that are sized to retain the smallest dimension of flatware and at the same time allow food debris to pass that there through. This construction, or any comparable construction, extends across the bottom 62 of catch basket 40 as well as the bottom 64 of catch basin 42, and similarly for catch basket 86 and catch basin 89. It is preferred that catch baskets 40, 86 be sized to allow removal from their respective recesses 41, 87 and their respective catch basins 42, 89 to allow easy access to flatware contained therein. Once in a flatware is retrieved the contents of catch baskets 40, 86 may be dumped into their respective chutes 38, 76. It is also preferred that catch basins 40, 86 be shaped to intercept the lateral movement of any items from their respective shoots 38, 76 to prevent the occurrence of any hazardous conditions.

It is generally preferred that the embodiments of the present invention be constructed of heavy duty washable molded material and also that they have a modular construction for easy repair and cleaning. It is also preferred that the various chutes and flat panels be easily removable from the apparatus for cleaning purposes and further sized appropriately to fit within commercial dishwashers.

The closure of doors or flat panels 22, 50, 80 by the various control units may be performed on a manual or automatic basis. Thus, the presence of flatware within the respective chutes may trigger the respective flat panels to close the respective chutes and remained in that condition until they are manually reset, for example by electrical operation. Alternatively, the various control units may be programmed to block the respective chut andes temporarily to divert whatever flatware was sensed and then automatically re-opened to allow continued use of the waste disposal unit.

Although the embodiments described herein generally referred to add occasion of the present invention to work with cylindrical garbage containers, such as a standard 32/44 gallon round garbage can, the apparatus of the present invention may of course be adapted to interface with various other shapes of garbage containers.

It is to be understood that the above-described embodiments are simply illustrative of the principles of the invention. Various modifications and changes may be made by those skilled in the art which will embody the principles of the invention and fall within the spirit and scope of the appended claims.

What is claimed is:

1. An apparatus for interrupting flatware from failing into a receptacle, comprising:
a housing adapted for location on top of a receptacle;
a chute mounted in the housing and having a vertical section with a bottom opening adapted to access a receptacle;
a side wall forming part of the vertical section and having a lateral opening there through;
a hinged panel adapted to selectively block the vertical section and deflect items falling in the vertical section through the lateral opening in the sidewall.

2. The apparatus of claim 1, further comprising a catch basin positioned adjacent to the lateral opening.

3. The apparatus of claim further comprising a removable catch basket adapted for location within the catch basin.

4. The apparatus of claim 3, wherein the removable catch basket has at least one partially enclosed side adapted to retain latterly moving flatware within the catch basket.

5. The apparatus of claim 4, wherein the catch basket has enclosed sides and top adapted to retain flatware moving through the lateral opening.

6. The apparatus of claim 5, further comprising a safety device adapted to prevent the movement of the hinged panel when the catch basket is not located within the catch basin.

7. The apparatus of claim 3, wherein the catch basket has an open mesh bottom sized to retain a smallest dimension of flatware.

8. The apparatus of claim 1, further comprising a metal detector adapted for sensing flatware moving either through or towards the chute and located within the housing and adjacent to the chute at a level higher than the lateral opening.

9. The apparatus of claim 1, wherein the hinged panel is hinged at either a top or bottom thereof.

10. The apparatus of claim 1, wherein the housing further includes one or more downwardly and laterally sloping surfaces extending to the chute and adapted to receive materials intended for the chute.

11. Of the apparatus of claim 1, wherein the chute is removable from the housing in a simple manner to facilitate washing.

12. A method for interrupting flatware from falling into a receptacle, comprising of the steps of:
allowing debris or other material potentially containing flatware to fall through a vertical chute toward a receptacle;
sensing the presence of flatware within the falling debris or other material;
moving a hinged panel across the vertical chute in response to the step of sensing to deflect such flatware laterally through an opening in a sidewall of the chute.

13. The method of claim 12, further comprising locating a catch basin adjacent the lateral opening in the chute to receive flatware moved through the chute by the step of moving a hinged panel.

14. The method of claim 13, further comprising locating a catch basket within the catch basin and adjacent to the lateral opening.

15. The method of claim 14, further comprising the step of retaining flatware moving through the lateral opening in the catch basket.

16. The method of claim 15, further comprising the step of disabling the step of moving if the catch basket is not located within the catch basin.

17. The method of claim 12, further comprising the step of initially receiving the debris or other material on a downwardly and laterally sloping surface adjoining the chute.
